(19) United States
(12) Patent Application Publication
(10) Pub. No.: US 2026/0336160 A1
(43) Pub. Date: Oct. 29, 2026

(54) Method of creating patterns with a 3D effect on the surface of semi-finished products and products made of dry bulk

(71) Applicant: Petr HASÍK, Caslav (CZ)

(72) Inventor: Petr HASÍK, Caslav (CZ)

(21) Appl. No.: 19/155,427

(22) PCT Filed: Feb. 13, 2024
(86) PCT No.: PCT/CZ2024/000003

§ 371 Date: Aug. 11, 2025

(30) Foreign Application Priority Data
Feb. 17, 2023 (CZ) PV 2023-62

(51) Int. Cl. B28B 1/04; B28B 11/00; B28B 11/04

(52) U.S. Cl. CPC B28B 1/045; B28B 11/001; B28B 11/048

(57) ABSTRACT

A method of creating patterns with a 3D effect on the surface of semi-finished products and products made of dry bulk, where dry bulk with a granulometry of 0.01 mm to 10 mm is poured into a circumferential mold and its surface is levelled. A 3D element is imprinted on the surface and when removed, paint is sprayed on the surface with the 3D element imprint at an angle of 89° to 1°; the subsequent further levelling of the surface creates a pattern with a visual 3D effect. Dry bulk in the mold and the surface after the creation of the imprint by the 3D element is levelled by pressing, rolling, vibration or a combination thereof.

### FIELD OF THE INVENTION

The method of creating patterns with a 3D effect on the surface of semi-finished products and products made of dry bulk allows wide application, especially in the construction industry.

### BACKGROUND OF THE INVENTION

The creation of the above-mentioned patterns is applied to materials the plasticity of which allows ductile deformation under the action of small external forces. Previously known decorations, created on the surface of dry bulk, which is subsequently compacted, are usually only colored without a plastic 3D effect.

### DETAILED DESCRIPTION OF THE INVENTION

Reference will now be made in detail to the presently preferred embodiments of the invention. There are also representative examples of the invention provided herein. The present disclosure, however, may be embodied in various forms, and should not be construed as being limited to only the examples herein. Rather, these examples are provided so that this disclosure will be thorough and complete, and will fully convey the aspects and features of the present disclosure to those skilled in the art.

The description provided herein is not intended to limit the claims to the specific embodiments so described. On the contrary, it is intended to cover alternatives, modifications, and equivalents as may be included within the spirit and scope of the present disclosure as defined by the appended claims.

Although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

In addition, when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, methods, operations, elements, and/or components, but do not preclude the presence or addition of one or more other features, integers, methods, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. In addition, terms such as those defined in commonly used dictionaries, should be interpreted as having a meaning that is consistent with their meaning in the context of the relevant art and will not be interpreted in an idealized or overly formal sense unless express so defined herein.

In the following description, numerous specific details are set forth in order to provide a thorough understanding of the present disclosure. The present disclosure may be practiced without some or even all of these specific details. In other instances, well-known process structures and/or processes have not been described in detail in order not to unnecessarily obscure the present disclosure. Further, the use of “may” when describing embodiments of the present disclosure refers to “one or more embodiments of the present disclosure.”

The present method of creating patterns with a 3D effect can be used in the production of building elements such as fence elements, building blocks, concrete tiles, concrete paving, etc., in the ceramic industry to decorate ceramics, in the glass industry to decorate glass products and also in the food industry to decorate confectionery products.

The above disadvantages are eliminated by the present method of creating patterns with a 3D effect on the surface of semi-finished products and products made of dry bulk according to the invention, the principle of which is that dry bulk with a granulometry of 0.01-10 mm is poured into the circumferential mold, the surface of the mold is levelled by compacting and a 3D element is imprinted on the surface. Compacting of dry bulk in the mold is done by pressing, rolling, vibration or a combination thereof. After removing the 3D element, paint is sprayed on the surface with the 3D element imprint at an angle of 89° to 1°. Subsequent compacting of the surface creates a pattern with a visual 3D effect. After the 3D element is imprinted, the surface is compacted by pressing, rolling or pressing together with the action of vibrations. If the created pattern is to be resistant to external forces, it is necessary to add reinforcing components to the dry bulk. Another option is to stabilize the created pattern with a transparent plate or expose the dry bulk to a temperature at which the dry bulk becomes a solid whole. The imprint of the element is made by a 3D element created on a straight die or by a die placed on a cylinder.

Suitable materials for the production method according to the invention are such semi-finished products where the necessary plasticity and later strength of the product is ensured by the interaction of forces between particles or the addition of other components such as water, acrylates, cements, resins, etc. The plasticity of the material is also affected by the shape of individual particles and the mutual force bonds between the individual particles. These can be affected primarily by choosing the right type of material and admixture of additional material to obtain the required plasticity. Correct granulometry affects both the plasticity of the material and the accuracy of the imprint. It is preferable to use materials consisting of multiple size fractions.

The resulting 3D effect of the pattern is also affected by the depth of the imprint: the smaller the plasticity of the material, the more it is necessary to reduce the depth of the imprint to prevent the destruction of the imprint when removing the die from the pattern or only when the force of gravity is applied. The depth of the imprint affects the resulting 3D effect; the smaller the plasticity of the material, the more it is necessary to reduce the depth of the imprint to prevent the destruction of the imprint when removing the die from the pattern or only when the force of gravity is applied. Large depth of the imprint has a negative effect on the sharpness of the pattern, due to the destruction of the imprint when comparing the surface.

The angle of the pigment application direction fundamentally affects the creation of a high-quality pattern with a 3D effect. The imprint disappears after comparing the surface at an angle of 90° between the surface and the pigment application direction as a result of the pigment uniformly painting the surface. Unpainted areas are created by gradually reducing the angle due to being shaded. On the contrary, by exceeding the optimal angle of pigment application towards lower angle values, the unpainted areas become larger and the resulting pattern loses its contours and is blurred.

### EXAMPLES OF INVENTION

### Example 1

Sand with a granulometry of 0.1 to 3 mm with a material moisture content of about 9% is used to create a 3D element. The material is compacted by pressing or rolling in a circumferential mold of any shape and a 3D element on a die is printed into the surface. After removing the element, the surface is spray-painted at an angle of 40° and compacted again by pressing or rolling. Contrast pigments can be used as a paint to match the color of dry bulk. The plasticity of these materials, together with the application of paint at the right angle, will create the desired pattern with a plastic 3D effect. This method of creating a 3D pattern can be used when decorating, for example, building elements.

### Example 2

Pottery clay with a granulometry of 0.1 to 0.5 mm mixed with a reinforcing component, in this case water, is used to create a 3D element. The material is compacted by pressing or rolling in a circumferential mold of any shape and a 3D element on a die is printed into the surface. After removing the element, the surface is spray-painted at an angle of 50° and compacted again by pressing or rolling. Contrast pigments can be used as a paint to match the color of dry bulk. The plasticity of these materials, together with the application of paint at the right angle, will create the desired pattern with a plastic 3D effect. In this case, the pattern will be stabilized on the item by the temperature while firing the ceramic. This method of creating a 3D pattern can be used when decorating, for example, ceramics.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method of creating a three-dimensional pattern onto a surface of a dry bulk article comprising the steps of:
placing granular material having granulometry of from 0.01 mm to 10.0 mm into a mold;
compacting for a first time the granular material within the mold;
imprinting a three-dimensional element into a surface of the granular material within the mold to create an imprinted surface:
painting the imprinted surface at an angle of from 1° to 89°; and
compacting for a second time the granular material within the mold.

2. The method of claim 1, wherein the step of compacting for a first time is done by a combination of pressing, rolling, and vibrating.

3. The method of claim 1, wherein the step of compacting for a second time is done by a combination of pressing, rolling, and vibrating.

4. (canceled)

5. The method of claim 1, wherein the granular material comprises reinforcing components.

6. (canceled) claim 1, wherein the three-dimensional element is done a die placed on a cylinder.

8. A method of creating a three-dimensional pattern onto a surface of a dry bulk article comprising the steps of:
placing granular material having granulometry of from 0.01 mm to 10.0 mm into a mold;
compacting for a first time the granular material within the mold;
imprinting a three-dimensional element into a surface of the granular material within the mold to create an imprinted surface;
curing the imprinted surface by heat;
painting the imprinted surface at an angle of from 1° to 89°;
compacting for a second time the granular material within the mold to create a rough finished dry bulk article; and
stabilizing the rough finished dry bulk article.

9. The method of claim 8, wherein the step of stabilizing is done by covering the rough finished dry bulk article with a transparent plate.

10. The method of claim 8, wherein the step of stabilizing is done by curing the rough finished dry bulk article until it is solid.
